(19) United States
(12) Patent Application Publication
(10) Pub. No.: US 2017/0047614 A1
(43) Pub. Date: Feb. 16, 2017

(54) SODIUM ION SECONDARY BATTERY

(71) Applicant: Sumitomo Electric Industries, Ltd., Osaka-shi (JP)

(72) Inventors: Shoichiro Sakai, Osaka-shi (JP); Atsushi Fukunaga, Osaka-shi (JP); Koma Numata, Osaka-shi (JP); Eiko Imazaki, Osaka-shi (JP); Koji Nitta, Osaka-shi (JP)

(21) Appl. No.: 15/307,195

(22) PCT Filed: Apr. 16, 2015
(86) PCT No.: PCT/JP2015/061720

§ 371 Date: Oct. 27, 2016

(30) Foreign Application Priority Data
May 2, 2014 (JP) 2014-095172

(51) Int. Cl. H01M 10/0568; H01M 2/02; H01M 2/04; H01M 2/06; H01M 4/131; H01M 4/133; H01M 4/1391; H01M 4/1393; H01M 4/04; H01M 4/485; H01M 4/587; H01M 4/62; H01M 4/66; H01M 2/16; H01M 2/08; H01M 10/054

(52) U.S. Cl. CPC H01M 10/0568; H01M 10/054; H01M 2/024; H01M 2/043; H01M 2/06; H01M 4/131; H01M 4/133; H01M 4/1391; H01M 4/1393; H01M 4/0404; H01M 4/0435; H01M 4/485; H01M 4/587; H01M 4/623; H01M 4/625; H01M 4/661; H01M 2/166; H01M 2/08; H01M 2004/027

(57) ABSTRACT

A sodium ion secondary battery includes an electrode group including a positive electrode and a negative electrode; an electrolyte, the electrode group being impregnated with the electrolyte; a case including a container with an opening portion and a sealing plate that closes the opening portion: and one or more insulating members, in which the electrolyte contains a molten salt, the molten salt contains cations and anions, the cations include a sodium ion and an organic cation, and all the insulating members are composed of a fluorine atom-free material.

### TECHNICAL FIELD

The present invention relates to a sodium ion secondary battery including an electrolyte that contains a molten salt, and in particular, to a sodium ion secondary battery including a molten salt that contains sodium ions and organic cations.

### BACKGROUND ART

In recent years, techniques for converting natural energy into electrical energy have been receiving attention. There has been increasing demand for nonaqueous electrolyte secondary batteries as high-energy-density batteries. In particular, lithium-ion secondary batteries have the advantage of being light in weight and having high electromotive forces. Lithium ion secondary batteries, however, include organic solvents used as main components of electrolytes and thus disadvantageously have low heat resistance. Furthermore, the price of lithium resources is rising.

There have been advances in the development of secondary batteries including flame-retardant molten salts serving as electrolyte components. Molten salts have excellent thermal stability, relatively easily ensure safety, and are also suited for continuous use at high temperatures. Among them, sodium ion secondary batteries using the Faradaic reaction of inexpensive sodium hold promises.

Ionic liquids containing sodium ions and organic cations have been receiving attention as molten salts (PTL 1).

Sodium ion secondary batteries including molten salts can be operated at higher temperatures than ordinary temperature (for example, 40° C. to 90° C.). Thus, fluororesins having high heat resistance and chemical resistance have been used for insulating members, such as separators, frames, and gaskets, from the viewpoint of suppressing a side reaction.

It is also reported that a fluororesin bag is used as an insulating bag that fixes a laminate including a positive electrode, a separator, and a negative electrode (PTL 2).

### CITATION LIST

### Patent Literature

PTL 1: Japanese Unexamined Patent Application Publication No. 2012-134126

PTL 2: Japanese Unexamined Patent Application Publication No. 2012-209071

### SUMMARY OF INVENTION

### Technical Problem

However, in sodium ion secondary batteries, when insulating members composed of fluorine atom-containing materials are present at positions where the insulating members can be in contact with electrolytes, the charge-discharge cycle characteristics of the sodium ion secondary batteries tend to degrade. An investigation of the cause of the degradation in cycle characteristics revealed that a reaction in which sodium abstracts fluorine atoms from the insulating members proceeded. It was also found that the insulating members in which fluorine atoms had been abstracted were highly reactive and the decomposition of molten salts was also induced.

Insulating members composed of fluorine atom-containing materials should essentially have high stability. In secondary batteries including organic solvents serving as electrolyte components, there is no manifestation of degradation in charge-discharge cycle characteristics due to the abstraction of fluorine atoms from the insulating members composed of the fluorine atom-containing materials. In sodium ion secondary batteries containing molten salts, however, the charge-discharge cycle characteristics are markedly degraded by the abstraction of fluorine atoms from the insulating members.

### Solution to Problem

In light of the foregoing description, an aspect of the present invention relates to a sodium ion secondary battery including an electrode group including a positive electrode and a negative electrode, an electrolyte, the electrode group being impregnated with the electrolyte, a case including a container with an opening portion and a sealing plate that closes the opening portion, and one or more insulating members, in which the electrolyte contains a molten salt, the molten salt contains cations and anions, the cations include a sodium ion and an organic cation, and all the insulating members are composed of a fluorine atom-free material.

### Advantageous Effects of Invention

The foregoing structure leads to improvement in the charge-discharge cycle characteristics of the sodium ion secondary battery containing the molten salt.

### BRIEF DESCRIPTION OF DRAWINGS

FIG. 1 is an exploded perspective view illustrating the schematic structure of a sodium ion secondary battery according to an embodiment of the present invention.

FIG. 2 is a longitudinal sectional view illustrating the structure of an external terminal and its vicinity included in a sodium ion secondary battery according to an embodiment of the present invention.

FIG. 3 is a cross-sectional view of a subgroup of the electrode group, the view being taken along line II-II of FIG. 1.

### DESCRIPTION OF EMBODIMENTS

First, embodiments of the present invention will be listed and described below.

(1) A sodium ion secondary battery according to an embodiment includes an electrode group including a positive electrode and a negative electrode, an electrolyte, the electrode group being impregnated with the electrolyte, a case including a container with an opening portion and a sealing plate that closes the opening portion, and one or more insulating members. The electrolyte contains a molten salt, the molten salt contains cations and anions, and the cations include a sodium ion and an organic cation. All the insulating members are composed of a fluorine atom-free material. The opening portion may be an opening portion used to insert the electrode group therethrough. All the insulating members are preferably free from a fluorine atom.

In sodium ion secondary batteries, various insulating members are used in order to prevent the occurrence of a short circuit. Commonly, fluororesins are used for the insulating members. The use of fluororesins seemingly improves the durability of sodium ion secondary batteries. However, in the case where all insulating members are composed of materials free from a fluorine atom (specifically, in the case where all the insulating members does not contain a fluororesin), a sodium ion secondary battery has improved charge-discharge cycle characteristics, compared with the case where a fluororesin is used for the insulating members. This is presumably because the degradation of a molten salt due to the insulating members is inhibited.

(2) The sodium ion secondary battery preferably includes an external terminal electrically connected to the positive electrode or the negative electrode. Preferably, the external terminal is partially exposed outside the case. In the sodium ion secondary battery, the insulating members preferably include a separator interposed between the positive electrode and the negative electrode, a frame interposed between the sealing plate and the electrode group, and a gasket that insulates the external terminal from the case. The gasket prevents the occurrence of a short circuit and also prevents the leakage of the electrolyte.

In the case where any one of the multiple insulating members including the separator, frame, and the gasket, is composed of a fluorine atom-containing material, it is difficult to improve the charge-discharge cycle characteristics. The volume or mass of the insulating members in all contents of the case is considerably large. Thus, the decomposition of organic cations is presumed to be easily manifested.

Sodium ion secondary batteries operate at relatively high temperatures and have high sodium ion concentrations in electrolytes. Thus, fluorine-atom abstraction reactions from insulating members seem to proceed readily. Once the fluorine-atom abstraction reactions proceed, the organic cations are seemingly decomposed to allow the degradation of the insulating members to proceed in a chain reaction manner. These side reactions also lead to degradation in charge-discharge cycle characteristics.

(3) In the sodium ion secondary battery, the insulating members preferably include an insulating sheet that at least partially covers a surface of the electrode group. The insulating sheet may be a bag capable of containing at least part of the electrode group or may be formed of one or more sheets folded to wrap the lower surface and side surfaces of the electrode group.

(4) In the case where the negative electrode includes a negative electrode current collector and a negative electrode mixture adhering to a surface of the negative electrode current collector, and where the negative electrode mixture contains a negative electrode active material and a binder, the binder is preferably composed of a fluorine atom-free material. This is because fluorine-atom abstraction by sodium ions can proceed inside the negative electrode. Preferably, the binder does not contain a fluorine atom.

At the positive electrode, substantially no fluorine-atom abstraction from the binder occurs because of a high electric potential and high stability of sodium ions.

The molten salt used here is defined the same as an ionic liquid and indicates a liquid ionic substance composed of an anion and a cation. At the positive electrode and the negative electrode of the sodium ion secondary battery, the Faradaic reactions with which sodium ions are associated proceed.

The electrolyte may contain, for example, an organic solvent and/or an additive, in addition to the molten salt. The concentration of the molten salt in the electrolyte is not particularly limited. In the case where the molten salt accounts for 10% by mass or more and even 20% by mass or more of the electrolyte, the effect of inhibiting degradation in charge-discharge cycle characteristics is markedly provided. Preferably, the molten salt accounts for 80% by mass or more, more preferably 90% by mass or more, and particularly preferably 100% by mass from the viewpoint of improving heat resistance.

Examples of the insulating members include separators, frames, gaskets, and insulating sheets. The type and number of the insulating members are not particularly limited as long as each of the insulating members is composed of a fluorine atom-free material.

The fluorine atom-free material contained in the insulating members is not particularly limited as long as it has low reactivity with the molten salt. Examples of the material that may be used include polyolefins, such as polyethylene (PE), polypropylene (PP), and ethylene-propylene copolymers; polyester resins, such as polyethylene terephthalate (PET), polybutylene terephthalate (PBT), and polycarbonate (PC); polyether resins, such as polysulfone (PS), polyether sulfone (PES), and polyphenylene ether (PPE); polyphenylene sulfide resins, such as polyphenylene sulfide (PPS) and polyphenylene sulfide ketone; polyamide resins, such as aromatic polyamide resins (e.g., aramid resins); polyimide resins; cellulosic resins; and paper. These may be used separately or in combination of two or more.

### Details of Embodiments of Invention

Specific examples of a sodium ion secondary battery according to embodiments of the present invention will be described below with appropriate reference to the drawing. The present invention is not limited to these examples. It is intended to include any modifications within the scope and meaning equivalent to the scope of the claims.

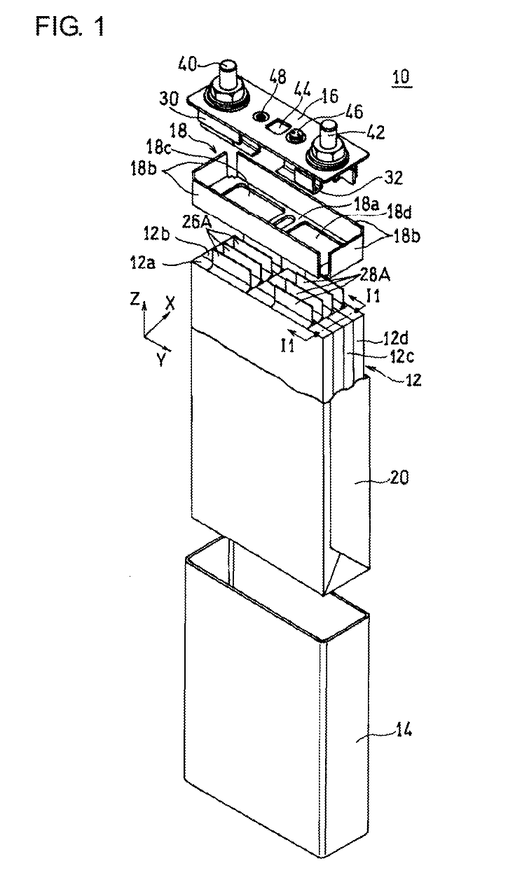

FIG. 1 is an exploded perspective view illustrating the schematic structure of a sodium ion secondary battery according to an embodiment.

A prismatic sodium ion secondary battery 10 illustrated includes a prismatic electrode group 12, a prismatic container 14 having an opening portion, and a sealing plate 16 that closes the opening portion of the container 14. The container 14 and the sealing plate 16 are composed of a metal. The container 14 and the sealing plate 16 are included in an electrically conductive case.

A frame 18 composed of a fluorine atom-free material is arranged between the sealing plate 16 and an upper surface of the electrode group 12. For example, the frame 18 serves to prevent the occurrence of a short circuit due to contact between the sealing plate 16 and a top end surface of the electrode group 12.

An insulating sheet 20 serving as an insulating member is arranged between the electrode group 12 and the container 14. In FIG. 1, the insulating sheet 20 is partially cut out in order to indicate the internal structure of the battery. The insulating sheet 20, in fact, covers all of the lower surface and four side surfaces of the electrode group 12. The insulating sheet 20 serves to physically isolate the electrode group 12 from the container 14 to prevent the occurrence of an internal short circuit.

The sealing plate 16 may be provided with a positive electrode external terminal 40 and a negative electrode external terminal 42. The positive electrode external terminal 40 is arranged at a position adjacent to one end portion of the sealing plate 16 in the longitudinal direction (Y-axial direction). The negative electrode external terminal 42 is arranged at a position adjacent to the other end portion.

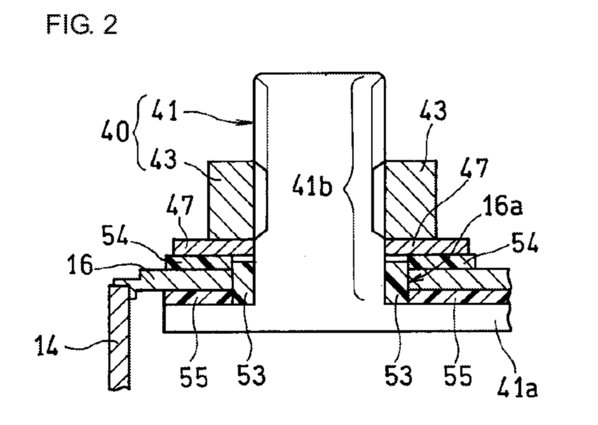

FIG. 2 is a longitudinal cross-sectional view illustrating the structure of the positive electrode external terminal 40 and its vicinity included in the sodium ion secondary battery 10. The negative electrode external terminal 42 has substantially the same structure as that of the positive electrode external terminal 40.

The positive electrode external terminal 40 includes a bolt-like terminal 41 that includes a head portion 41a and a screw portion 41b extending therefrom; and a nut 43 attached to the screw portion 41b of the bolt-like terminal 41. The bolt-like terminal 41 is inserted in a circular terminal hole 16a arranged in the sealing plate 16 from the inside of the case to the outside. A ring-shaped first gasket 53 serving as an insulating member is arranged between the peripheral portion of the terminal hole 16a and the screw portion 41b of the bolt-like terminal 41. The first gasket 53 is attached to the screw portion 41b of the bolt-like terminal 41.

The head portion 41a of the bolt-like terminal 41 is larger in size than the diameter of the terminal hole 16a. The nut 43 is attached to the screw portion 41b protruding outward from the sealing plate 16 and tightened with respect to the head portion 41a, so that the bolt-like terminal 41 is fixed to the sealing plate 16.

An O-ring-shaped metal washer 47 is arranged between the nut 43 and the sealing plate 16. An O-ring-shaped second gasket 54 serving as an insulating member is arranged between the washer 47 and the sealing plate 16.

A third gasket 55 is arranged between the head portion 41a of the bolt-like terminal 41 and the sealing plate 16. The third gasket 55 may have substantially the same shape and size as those of the head portion 41a of the bolt-like terminal 41.

A vent valve 44 (for example, a rupture valve) configured to release a gas in the case at the time of an abnormal increase in internal pressure in the case may be arranged in the middle portion of the sealing plate 16. A pressure regulating valve 46 and an inlet 48 may be arranged in the vicinity of the vent valve 44. The inlet 48 is a hole through which an electrolyte is injected into the case after the sealing plate 16 is attached to the opening portion of the container 14. The inlet 48 is plugged with a plug (not illustrated).

In this embodiment, the electrode group 12 is formed of a laminate including the positive electrode and the negative electrode alternately stacked and has the upper surface, the lower surface, and the four flat side surfaces. The outer shape of the electrode group 12 is a prismatic column close to a rectangular parallelepiped. The electrode group 12 includes a plurality of subgroups 12a, 12b, 12c, and 12d (four subgroups illustrated in the figure).

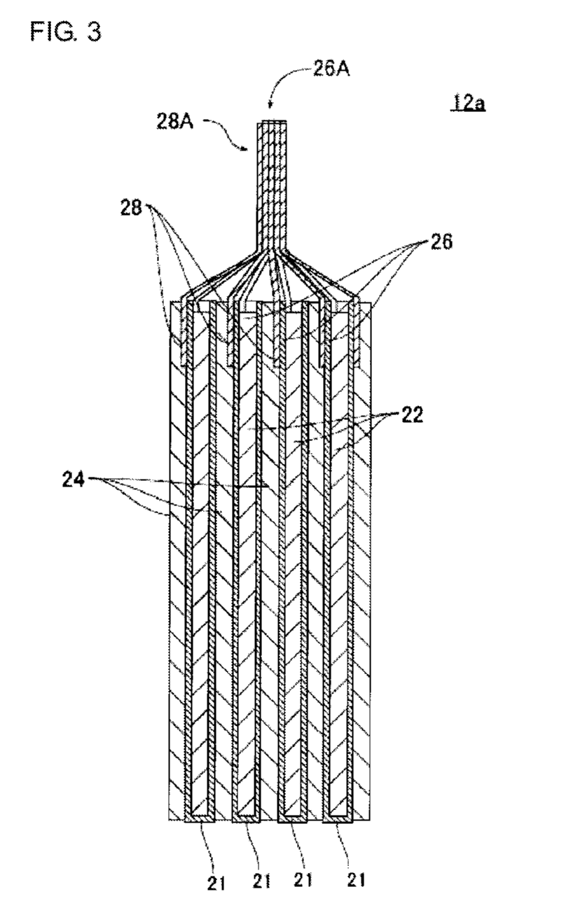

FIG. 3 is a cross-sectional view of a subgroup of an electrode group. This cross-sectional view is a cross-sectional view when the subgroup 12a is cut with respect to a plane including line II-II of FIG. 1 and perpendicular to the Y axis. The number of electrodes (positive electrodes and negative electrodes illustrated in the figure) is not necessarily equal to the number of the electrodes actually included in the subgroup 12a. The other subgroups 12b to 12d have the same structure as that of the subgroup 12a.

The subgroup 12a of the electrode group 12 has a structure in which a plurality of positive electrodes 22 contained in bag-shaped separators 21 serving as insulating members and a plurality of negative electrodes 24 are alternately stacked. Each of the positive electrodes 22 includes a positive electrode current collector and a positive electrode active material. Each of the negative electrodes 24 includes a negative electrode current collector and a negative electrode active material. In FIG. 3, the positive electrode current collector, the positive electrode active material, the negative electrode current collector, and the negative electrode active material are not distinctively illustrated. The shape of each of the separators 21 is not limited to the bag shape. The separators 21 serve to physically isolate the positive electrodes 22 from the negative electrodes 24 to prevent the occurrence of an internal short circuit. The separators 21 are composed of a porous material with pores filled with the electrolyte.

A lead strip (positive electrode lead strip) 26 is attached to an upper end portion of each of the multiple positive electrodes 22 (or the positive electrode current collectors). The positive electrode lead strips 26 may be formed integrally with the positive electrodes 22 or the positive electrode current collectors, respectively. The lead strips of the multiple positive electrodes 22 of the subgroup 12a are bundled and, for example, welded together, so that these positive electrodes 22 are connected in parallel.

A bundle portion 26A of the positive electrode lead strips 26 (hereinafter, referred to as a “positive electrode lead strip bundle portion”) is connected to an electrically conductive positive electrode connection member 30 (see FIG. 1). The positive electrode connection member 30 is electrically connected to the positive electrode external terminal 40. The other subgroups 12b to 12d each include the positive electrode lead strip bundle portion 26A. In the structure described above, all the positive electrodes 22 of the electrode group 12 are parallel-connected to the positive electrode external terminal 40.

Similarly, a lead strip (negative electrode lead strip) 28 is attached to an upper end portion of each of the multiple negative electrodes 24 (or negative electrode current collectors). The lead strips of the multiple negative electrodes 24 of the subgroup 12a are bundled and, for example, welded together, so that the multiple negative electrodes 24 are connected in parallel.

A bundle portion 28A of the negative electrode lead strip 28 (hereinafter, referred to as a “negative electrode lead strip bundle portion) is connected to an electrically conductive negative electrode connection member 32 (see FIG. 1). The negative electrode connection member 32 is electrically connected to the negative electrode external terminal 42. The other subgroups 12b to 12d each include the negative electrode lead strip bundle portion 28A. In the structure described above, all the negative electrodes 24 of the electrode group 12 are parallel-connected to the negative electrode external terminal 42.

The frame 18 is arranged between the sealing plate 16 and the upper surface of the electrode group 12 so as to prevent the electrically conductive container 14 from coming into contact with the positive electrode lead strip bundle portions 26A, the negative electrode lead strip bundle portions 28A, the positive electrode connection member 30, and the negative electrode connection member 32. In the case illustrated, the frame 18 includes a basal plate 18a having a substantially rectangular shape in outline and four surrounding wall portions 18b extending upright from four sides of the basal plate 18a. The basal plate 18a includes a hole 18c for insertion of the positive electrode lead strip bundle portions 26A of the subgroups 12a to 12d; and a hole 18d for insertion of the negative electrode lead strip bundle portions 28A of the subgroups 12a to 12d. The four surrounding wall portions 18b surround the positive electrode lead strip bundle portions 26A, the negative electrode lead strip bundle portions 28A, the positive electrode connection member 30, and the negative electrode connection member 32, thereby preventing these electrically conductive members from coming into contact with the container 14.

In the foregoing embodiment, the frame, the insulating sheets, the gaskets, and the separators are used as the insulating members. Each of the insulating members is composed of a fluorine atom-free material.

As a material for the frame 18, a formed article composed of a fluorine atom-free resin is preferred. The formed article may be produced by a processing method, for example, punching of a resin sheet or transfer molding of a raw material resin composition. Preferred examples of the resin sheet and the raw material resin include polyolefin resins, polyamide resins, polyimide resins, polyester resins, polyether resins, and cellulosic resins. Paper may be used as a material for the frame.

As a material for the insulating sheet 20, a sheet composed of a fluorine atom-free resin is preferred. Preferred examples of the material for the sheet include polyolefin resins, polyphenylene sulfide resins, polyamide resins, and polyimide resins. As a material for the insulating sheet 20, paper may be used. These materials may be used separately or in combination of two or more.

As a material for the separators 21, for example, microporous membranes or nonwoven fabrics composed of a fluorine atom-free resin are preferred. Each of the separators 21 may be formed of a multilayer component having a plurality of layers with different compositions and shapes. As a material for the microporous membranes and nonwoven fabrics, the same materials as those used for the insulating sheet 20 may be used separately or in combination of two or more. In the case of the nonwoven fabrics, inorganic fibers, such as glass fibers, may be used.

The separators composed of the resin may contain an inorganic filler. Examples of the inorganic filler include ceramics, such as silica, alumina, zeolite, and titania, talc, mica, and wollastonite. The inorganic filler is preferably in the form of particles or fibers. Each of the separators has an inorganic filler content of, for example, 10% to 90% by mass and preferably 20% to 80% by mass.

As a material for the first gasket 53, the second gasket 54, and the third gasket 55, formed articles composed of a fluorine atom-free resin are preferred. The formed articles may be produced by a processing method, for example, punching of a resin sheet or transfer molding of a raw material resin composition. Preferred examples of the resin sheet and the raw material resin include polyether resins, polyphenylene sulfide resins, and rubbery polymers (e.g., silicone rubber, butyl rubber, acrylic rubber, urethane rubber, and ethylene propylene rubber).

The electrodes and the electrolyte functioning as power-generating elements of the sodium ion secondary battery will be described below.

Each positive electrode 22 or each negative electrode 24 is formed by, for example, applying an electrode mixture to current collectors composed of metal foil and optionally pressing the current collectors and the electrode mixture together in the thickness direction. The electrode mixture contains an active material as an essential component and may contain a conductive assistant and/or a binder as an optional component. The electrode mixture is formed into an active material layer.

The active material layer may be formed by the deposition of the active material on the current collector by a plating method and/or a gas-phase method (for example, evaporation).

As the negative electrode active material for the sodium ion secondary battery, a material that reversibly intercalates and deintercalates sodium ions may be used. Examples of the material include carbon materials, spinel-type lithium titanium oxide, and spinel-type sodium titanium oxide. As the carbon material, non-graphitizable carbon (hard carbon) is preferred. As the negative electrode active material for the sodium ion secondary battery, a material containing an element that can be alloyed with sodium may be used. Examples of the element that can be alloyed with sodium include silicon, tin, zinc, indium, antimony, lead, bismuth, and phosphorus. The material containing the element may be in the form of an element, an alloy, or a compound. Specific examples of the material containing the element include silicon oxide, silicon alloys, elemental silicon, tin oxide, tin alloys, elemental tin, zinc oxide, zinc alloys, and elemental zinc. For the negative electrode active material, these materials may be used separately or in combination of multiple types thereof.

As the positive electrode active material for the sodium ion secondary battery, a transition metal compound that reversibly intercalates and deintercalates sodium ions is preferably used. As the transition metal compound, sodium-containing transition metal oxide is preferably used. Examples of the sodium-containing transition metal oxide include NaCrO₂, NaNi_{0.5}Mn_{0.5}O₂, NaMn_{1.5}Ni_{0.5}O₄, NaFeO₂, NaFeₓ(Ni_{0.5}Mn_{0.5})₁₋ₓO₂ (0<x<1), Na_{2/3}Fe_{1/3}Mn_{2/3}O₂, NaMnO₂, NaNiO₂, NaCoO₂, and Na_{0.44}MnO₂. For the positive electrode active material, these materials may be used separately or in combination of multiple types thereof.

In the case where a negative electrode mixture to be formed into a negative electrode active material layer contains a negative electrode active material and a binder, the binder is preferably composed of a fluorine atom-free material. The binder is preferably composed of a fluorine atom-free polymer. The amount of the binder is, for example, 1 to 10 parts by mass and preferably 2 to 7 parts by mass with respect to 100 parts by mass of the negative electrode active material.

For electrodes of conventional sodium ion secondary batteries, fluororesins, such as polyvinylidene fluoride (PVDF), are commonly used as binders. However, when fluorine atom abstraction reactions of sodium from binders occur inside negative electrodes, binders are degraded, possibly causing degradation in charge-discharge cycle characteristics.

The fluorine atom-free polymer may be a synthetic polymer, a natural polymer, or a treated product thereof. Examples of the natural polymer and the treated product thereof include polysaccharides, such as cellulosic resins (e.g., cellulose ether or cellulose ester). Examples of the synthetic polymer include thermoplastic resins and thermosetting resins. A single-type of polymer may be used alone. Two or more types of polymers may be used in combination.

Examples of the cellulosic resins include cellulose ethers, such as carboxyalkyl cellulose, e.g., carboxymethyl cellulose (CMC) and salts thereof (such as, alkali metal salts of CMC, e.g., a sodium salt of CMC), hydroxyalkyl cellulose, e.g., hydroxyethyl cellulose; and cellulose esters, such as acetylcellulose.

Examples of the synthetic polymer include polyamide resins, polyimide resins, acrylic resins, polyolefin resins, vinyl resins, vinyl cyanide resins, polyphenylene oxide resins, polyphenylene sulfide resins, and rubbery polymers. The polymer has a weight-average molecular weight of, for example, 10,000 or more and preferably 20,000 or more. The polymer has a weight-average molecular weight of, for example, 500,000 or less and preferably 200,000 or less.

The molten salt in the electrolyte contains cations and anions. The cations include sodium ions and organic cations. The molten salt contains at least two types of salts. One of the two types of salts is a salt of a sodium ion and a first anion. The other is a salt of an organic cation and a second anion. The sodium ion and the organic cation preferably account for 80% by mole or more, more preferably 90% by mole or more, and particularly preferably 100% by mole of the cations in the molten salt.

The proportion of the sodium ion is preferably 10% by mole or more and more preferably 20% by mole or more with respect to the total of the sodium ion and the organic cation. The proportion of the sodium ion is preferably 90% by mole or less and more preferably 80% by mole or less.

The first anion and the second anion each independently indicate, for example, a fluorine-containing acid anion (for example, PF₆⁻ or BF₄⁻), a chlorine-containing acid anion (ClO₄⁻), a bis(sulfonyl)amide anion, or a trifluoromethanesulfonate ion (CF₃SO₃⁻). Of these, the bis(sulfonyl)amide anion is preferred.

As the bis(sulfonyl)amide anion, for example, a bis(fluorosulfonyl)amide anion ((N(SO₂F)₂⁻) (FSA⁻), a bis(trifluoromethylsulfonyl)amide anion (N(SO₂CF₃)₂⁻) (TFSA⁻), or a fluorosulfonyl)(trifluoromethylsulfonyl)amide anion (N(SO₂F)(SO₂CF₃)⁻) is preferred.

As the organic cation, a quaternary ammonium cation, a pyrrolidinium cation, or an imidazolium cation is preferred.

Examples of the quaternary ammonium cation include tetraalkylammonium cations (in particular, for example, tetraC₁₋₅alkylammonium cations), such as a tetraethylammonium cation (TEA⁺) and a triethylmethylammonium cation (TEMA⁺). Examples of the pyrrolidinium cation include a 1-methyl-1-propylpyrrolidinium cation (Py13), a 1-butyl-1-methylpyrrolidinium cation (Py14), and a 1-ethyl-1-propylpyrrolidinium cation. Examples of the imidazolium cation include a 1-ethyl-3-methylimidazolium cation (EMI) and a 1-butyl-3-methylimidazolium cation (BMI).

The embodiments will be specifically described below on the basis of examples. However, the present invention is not limited to these examples described below.

### Example 1

### Production of Positive Electrode

First, 85 parts by mass of NaCrO₂ (positive electrode active material) having an average particle diameter of 10 μm, 10 parts by mass of acetylene black (electrically conductive agent), and 5 parts by mass of polyvinylidene fluoride (PVDF) (binder) were dispersed in N-methyl-2-pyrrolidone (NMP) to prepare a positive electrode paste. The resulting positive electrode paste was applied to both surfaces of aluminum foil (with a thickness of 20 μm), sufficiently dried, and rolled to produce a positive electrode having an overall thickness of 180 μm, the positive electrode including a positive electrode active material layer on each surface thereof, and the positive electrode active material layer having a thickness of 80 μm.

The positive electrode was cut into 100×100 mm squares to prepare 10 positive electrodes. A lead strip for current collection was formed on an end portion of a side of each of the positive electrodes.

### (Production of Negative Electrode)

First, 95 parts by mass of hard carbon (negative electrode active material) and 5 parts by mass of polyamide-imide (binder) were dispersed in NMP to prepare a negative electrode paste. The negative electrode paste was applied to both surfaces of aluminum foil (with a thickness of 20 μm), sufficiently dried, and rolled to produce a negative electrode having an overall thickness of 150 μm, the negative electrode including a negative electrode active material layer on each surface thereof, and the negative electrode active material layer having a thickness of 65 μm.

The negative electrode was cut into 105×105 mm squares to prepare 11 negative electrodes. A lead strip for current collection was formed on an end portion of a side of each of the negative electrodes. Two of the 11 negative electrodes were electrodes each including the negative electrode active material layer on only a surface thereof.

### (Separator)

A 50-μm-thick separator (with a porosity of 70%) composed of a silica-containing polyolefin was prepared. The separator was cut into 110×110 mm pieces to prepare 20 separators.

### (Electrolyte)

An electrolyte composed of 100% of a mixture of sodium bis(fluorosulfonyl)amide (NaFSA) and 1-methyl-1-propylpyrrolidinium bis(fluorosulfonyl)amide (Py13FSA) in a molar ratio of 30:70 was prepared.

### (Assembly of Sodium Ion Secondary Battery)

The positive electrodes and the negative electrodes were stacked in such a manner that the separators were provided between the positive electrodes and the negative electrodes, the positive electrode lead strips were stacked together, the negative electrode lead strips were stacked together, and the bundle of the positive electrode lead strips and the bundle of the negative electrode lead strips were arranged in bilaterally symmetric positions, thereby producing an electrode group. Each of the negative electrodes each having the negative electrode active material layer provided on only one surface thereof was arranged at a corresponding one of end portions of the electrode group.

Subsequently, an insulating sheet (with a thickness of 20 μm) composed of polypropylene was folded so as to cover the lower surface and the four side surfaces of the electrode group. The electrode group covered with the insulating sheet was housed in a container composed of aluminum.

A frame composed of polypropylene was arranged on the upper surface of the electrode group. An opening portion of the container was closed with a sealing plate. Prior to closing the opening, the bundles of the lead strips were connected to predetermined connection members arranged on the sealing plate.

The sealing plate was provided with a positive electrode external terminal and a negative electrode external terminal. Gaskets composed of polypropylene were interposed between the sealing plate and each terminal to ensure insulation.

The electrolyte was injected into the resulting case through an inlet formed in the sealing plate. The resulting article was allowed to stand until the electrode group was sufficiently impregnated with the electrolyte. Preliminary charging and discharging and a predetermined degassing operation were performed to complete battery A1 of Example 1.

### Comparative Example 1

Battery B1 according to Comparative example 1 was produced as in Example 1, except that a frame composed of polytetrafluoroethylene (PTFE) was used.

### Comparative Example 2

Battery B2 according to Comparative example 2 was produced as in Example 1, except that an insulating sheet (with a thickness of 18 μm) composed of PTFE was used.

### Comparative Example 3

Battery B3 according to Comparative example 3 was produced as in Example 1, except that gaskets composed of PTFE were interposed between each terminal and the sealing plate.

### [Charge-Discharge Cycle Test]

The resulting batteries (battery A1 and batteries B1 to B3) were maintained at 60° C. in a temperature-controlled bath. Constant-current charge-discharge operation was repeated 500 cycles at a current rate of 0.2 It in the range of 1.5 to 3.5 V. The ratio of the discharge capacity at the final discharge to the initial discharge capacity is defined as a capacity maintenance ratio and calculated. Table 1 lists the capacity maintenance ratios of the example (battery A1) and the comparative examples (batteries B1 to B3).

TABLE 1

| Battery | Capacity maintenance ratio (%) |
|---|---|
| A1 | 91 |
| B1 | 78 |
| B2 | 45 |
| B3 | 87 |

The capacity maintenance ratio of battery A1 of the example is 90% or more and higher than those of batteries B1 to B3 of the comparative examples.

After the completion of the charge-discharge cycle test, the batteries were disassembled. In battery A1 of the example, the insulating members, such as the frame, were not discolored. In batteries B1 to B3 of the comparative examples, the insulating members composed of PTFE were discolored. The results demonstrated that degradation proceeded.

### INDUSTRIAL APPLICABILITY

The sodium ion secondary battery according to the present invention is useful for, for example, large-scale power storage apparatuses for household and industrial use and power sources for electric vehicles and hybrid vehicles.

### REFERENCE SIGNS LIST

10 sodium ion secondary battery, 12 electrode group, 12a to 12d subgroup, 14 container, 16 sealing plate, 16a terminal hole, 18 frame, 20 insulating sheet, 21 separator, 22 positive electrode, 24 negative electrode, 26 positive electrode lead strip, 26A positive electrode lead strip bundle portion, 28 negative electrode lead strip, 28A negative electrode lead strip bundle portion, 30 positive electrode connection member, 32 negative electrode connection member, 40 positive electrode external terminal, 41 bolt-like terminal, 41a head portion, 41b screw portion, 42 negative electrode external terminal, 43 nut, 44 vent valve, 46 pressure regulating valve, 47 metal washer, 48 inlet, 53 first gasket, 54 second gasket, 55 third gasket

1. A sodium ion secondary battery comprising:
an electrode group including a positive electrode and a negative electrode;
an electrolyte, the electrode group being impregnated with the electrolyte;
a case including a container with an opening portion and a sealing plate that closes the opening portion; and
one or more insulating members,
wherein the electrolyte contains a molten salt,
the molten salt contains cations and anions,
the cations include a sodium ion and an organic cation, and
all the insulating members are composed of a fluorine atom-free material.

2. The sodium ion secondary battery according to claim 1, further comprising:
an external terminal electrically connected to the positive electrode or the negative electrode,
wherein the external terminal is partially exposed outside the case,
wherein the insulating members include
a separator interposed between the positive electrode and the negative electrode,
a frame interposed between the sealing plate and the electrode group, and
a gasket that insulates the external terminal from the case.

3. The sodium ion secondary battery according to claim 1, wherein the insulating members include an insulating sheet that covers at least part of a surface of the electrode group.

4. The sodium ion secondary battery according to claim 1, wherein the negative electrode includes a negative electrode current collector and a negative electrode mixture adhering to a surface of the negative electrode current collector,
the negative electrode mixture contains a negative electrode active material and a binder, and
the binder is composed of a fluorine atom-free material.
